(19) United States
(12) Patent Application Publication
(10) Pub. No.: US 2026/0321143 A1
(43) Pub. Date: Oct. 15, 2026

(54) DUAL SCREEN DISPLAY METHOD AND SYSTEM FOR UNMANNED AERIAL VEHICLE BASED ON EMBEDDED MAP

(71) Applicant: Shenzhen Huiyuan Innovation Technology Co., Ltd., Shenzhen (CN)

(72) Inventors: Chaoxian Zhang, Shenzhen (CN); Bai'ao Li, Zhongxiang (CN)

(21) Appl. No.: 19/683,013

(22) Filed: May 20, 2026

Related U.S. Application Data
(63) Continuation of application No. PCT/CN2026/095923, filed on May 9, 2026.

(30) Foreign Application Priority Data
Mar. 11, 2025 (CN) 202510285447.6

(51) Int. Cl. G08G 5/23; G06V 10/26; G06V 20/17; G06V 20/40; G06V 20/58; G08G 5/57

(52) U.S. Cl. CPC G08G 5/23; G06V 10/26; G06V 20/17; G06V 20/41; G06V 20/58; G08G 5/57

(57) ABSTRACT

Provided are a method and system for dual screen display of an unmanned aerial vehicle based on an embedded map. The method includes calibrating the flight data and environmental perception data; marking a position and a flight trajectory of the unmanned aerial vehicle and marking an obstacle element in a corresponding flight area of the unmanned aerial vehicle; calculating an obstacle coefficient of the obstacle element and performing three-dimensional reconstruction of the obstacle element in the embedded map to obtain the embedded obstacle map; establishing an obstacle avoidance path for the unmanned aerial vehicle and constructing a first display screen; constructing an identification box and attribute information of a video subject, constructing a second display screen of the unmanned aerial vehicle, establishing a dual screen collaboration rule of the unmanned aerial vehicle, and executing a dual screen display of the first display screen and the second display screen.

### CROSS-REFERENCE TO RELATED APPLICATIONS

This application is a continuation of International Application No. PCT/CN2026/095923, filed on May 9, 2026, which claims priority to Chinese Patent Application No. 202510285447.6, filed on Mar. 11, 2025. Both of which are hereby incorporated by reference in their entireties.

### TECHNICAL FIELD

The present disclosure relates to the field of unmanned aerial vehicle technologies, and in particular, to a dual screen display method and a system for an unmanned aerial vehicle based on an embedded map.

### BACKGROUND

A dual screen display of unmanned aerial vehicles refers to the use of two screens to simultaneously display different information or different perspectives of the same information in an unmanned aerial vehicle system. The dual screen display system of unmanned aerial vehicles improves operational efficiency and safety, enabling unmanned aerial vehicle operators to better perform complex tasks and make quick decisions.

The traditional dual screen display method for unmanned aerial vehicles usually involves one screen displaying flight data and map information according to a predetermined flight path, and the other screen displays real-time video from the camera. This method cannot integrate environmental perception data and real-time analysis, and cannot provide more comprehensive situational awareness, which lacks real-time data fusion and cannot effectively display obstacle avoidance paths and obstacle information, resulting in poor operational efficiency and safety in complex tasks.

### SUMMARY

The present disclosure provides a method and a system for a dual screen display of an unmanned aerial vehicle based on an embedded map, with the main objective of improving the operational efficiency of unmanned aerial vehicles in complex tasks.

To achieve the above objectives, the present disclosure provides a dual screen display method for an unmanned aerial vehicle based on an embedded map, including:
obtaining flight data and environmental perception data of the unmanned aerial vehicle on the embedded map, where the flight data includes position, altitude, velocity, and attitude information, and the environmental perception data includes laser radar point cloud data, infrared image data, and ultrasonic sensor data; calibrating the flight data and environmental perception data to obtain calibrated flight data and calibrated environmental perception data;
marking a position and a flight trajectory of the unmanned aerial vehicle based on the calibrated flight data, and marking an obstacle element in a corresponding flight area of the unmanned aerial vehicle based on the calibrated environment perception data;
calculating an obstacle coefficient of the obstacle element and performing three-dimensional reconstruction of the obstacle element in the embedded map to obtain the embedded obstacle map based on the obstacle coefficient;
establishing an obstacle avoidance path for the unmanned aerial vehicle based on a preset unmanned aerial vehicle target location, unmanned aerial vehicle position, unmanned aerial vehicle flight trajectory, and embedded obstacle map, constructing a first display screen for the unmanned aerial vehicle based on the unmanned aerial vehicle position, unmanned aerial vehicle flight trajectory, embedded obstacle map, and obstacle avoidance path;
obtaining real-time flight video of the unmanned aerial vehicle, identifying a video subject of the real-time flight video, constructing an identification box and attribute information of the video subject, constructing a second display screen of the unmanned aerial vehicle based on the video subject, identification box, and attribute information, establishing a dual screen collaboration rule of the unmanned aerial vehicle, and executing a dual screen display of the first display screen and the second display screen according to the dual screen collaboration rule.

In some embodiments of the present disclosure, calibrating the flight data and environmental perception data to obtain calibrated flight data and calibrated environmental perception data, includes:
identifying a sensor type for the flight data and environmental perception data;
analyzing flight data characteristics and environmental perception data characteristics of the flight data and environmental perception data;
defining a joint calibration algorithm for the flight data and environmental perception data based on the sensor type, flight data characteristics, and environmental perception data characteristics;
determining a feasible parameter range of the joint calibration algorithm;
calibrating the flight data and environmental perception data using the joint calibration algorithm through the feasible parameter range and obtaining the calibrated flight data and calibrated environmental perception data.

In some embodiments of the present disclosure, marking a position and a flight trajectory of the unmanned aerial vehicle based on the calibrated flight data, includes:
extracting a position information from the calibrated flight data and determining the position of the unmanned aerial vehicle based on the position information;
marking a trajectory starting point of the unmanned aerial vehicle;
defining a trajectory data structure of the unmanned aerial vehicle based on the trajectory starting point;
determining trajectory points of the unmanned aerial vehicle based on the position information;
adding the trajectory points to the trajectory data structure to obtain an initial flight trajectory of the unmanned aerial vehicle;
performing smooth treatment on the initial flight trajectory to obtain the unmanned aerial vehicle flight trajectory of the unmanned aerial vehicle.

In some embodiments of the present disclosure, performing smooth treatment on the initial flight trajectory to obtain the unmanned aerial vehicle flight trajectory of the unmanned aerial vehicle, includes:
defining a sliding window for the initial flight trajectory;
determining a trajectory point weight corresponding to the initial flight trajectory;
calculating a smoothness coefficient of the trajectory point using the following formula based on the sliding window and trajectory point weight:

$${P}_{k} = {\sum }_{c = k - N / 2}^{k + N / 2} {ρ}_{c} {ω}_{c} / {\sum }_{c = k - N / 2}^{k + N / 2} {ρ}_{c}$$

where Pₖ represents the smoothness coefficient of the trajectory point corresponding to the time point k, k represents the time point k, N represents a size of the sliding window, ω_{c} represents a trajectory point at the time point c, and ρc represents the trajectory point weight corresponding to the trajectory point at the time point c;
preforming smooth treatment on the initial flight trajectory based on the smoothness coefficient to obtain the unmanned aerial vehicle flight trajectory.

In some embodiments of the present disclosure, marking the obstacle element corresponding to the flight area of the unmanned aerial vehicle based on the calibrated environmental perception data, includes:
determining a RGB image of the flight area, three-dimensional point cloud data, and detecting a heat source based on the calibrated environmental perception data;
performing subject separation on the RGB image of the flight area to obtain an image subject;
using the three-dimensional point cloud data to supplement depth information of the image subject and obtaining a supplementary image subject;
extracting image subject features and heat source features of the supplementary image subject and a detected heat source;
using a trained obstacle recognition model to identify the obstacle element in the flight area based on the image subject features and heat source features.

In some embodiments of the present disclosure, calculating the obstacle coefficient of the obstacle element, includes:
identifying an obstacle type of the obstacle element, where the obstacle type includes a static obstacle, a dynamic obstacle, and a living obstacle;
extracting obstacle features of the obstacle type, where the obstacle features include an obstacle distance, an obstacle volume, an obstacle dynamism, and a heat source value;
defining obstacle feature scores for the obstacle features;
normalizing the obstacle features to obtain normalized obstacle features, where the normalized obstacle features include a normalized obstacle distance, a normalized obstacle volume, a normalized obstacle dynamism, and a normalized heat source value;
calculating the obstacle coefficient of the obstacle element based on the normalized obstacle distance, normalized obstacle volume, normalized obstacle dynamism, normalized heat source value, and obstacle feature scores.

In some embodiments of the present disclosure, calculating the obstacle coefficient of the obstacle element based on the normalized obstacle distance, normalized obstacle volume, normalized obstacle dynamism, normalized heat source value, and obstacle feature scores, includes:
defining an environmental impact factor of the obstacle element, where the environmental impact factor includes wind velocity and lighting conditions;
calculating the obstacle coefficient of the obstacle element using the following formula based on the wind velocity, lighting conditions, normalized obstacle distance, normalized obstacle volume, normalized obstacle dynamism, normalized heat source value, and obstacle feature scores:

Uₒ=(ω_{d}·dₙ+ωₛ·sₙ+ωᵥ·vₙ+ωₕ·hₙ)·(1+α·wind+σ·light)
where, Uₒ represents the obstacle coefficient of the obstacle element, dₙ represents the normalized obstacle distance, ω_{d} represents an obstacle feature score of the normalized obstacle distance, Sₙ represents the normalized obstacle volume, ωₛ represents an obstacle feature score of the normalized obstacle volume, vₙ represents the normalized obstacle dynamism, co represents an obstacle feature score of the normalized obstacle dynamism, hₙ represents the normalized heat source value, ωₕ represents an obstacle feature score of the normalized heat source value, wind represents the wind velocity, α represents an influence weight of the wind velocity, light represents the lighting conditions, and σ represents an influence weight of the lighting conditions.

In some embodiments of the present disclosure, performing three-dimensional reconstruction of the obstacle element in the embedded map to obtain the embedded obstacle map based on the obstacle coefficient, includes:
determining a to-be-modeled element for the obstacle element based on the obstacle coefficient;
collecting point cloud data of the to-be-modeled element;
denoising the point cloud data of the to-be-modeled element to obtain denoised element-point cloud data;
determining a reference point cloud of the embedded map;
defining a rotation matrix of the denoised element-point cloud data in the embedded map;
calculating a map position and orientation of a sensor corresponding to the denoised element-point cloud data on the embedded map using the following formula based on the reference point cloud, rotation matrix, and element-point cloud data:

$$E = {\sum }_{e = 1}^{m} {‖ {p}_{e} - R ( {q}_{e} ) - t ‖}^{2}$$

where, E represents a map position and orientation of an e^{th} denoised element-point cloud data sensor in the embedded map, pₑ represents a point position corresponding to the e^{th} denoised element-point cloud data captured by the sensor in the reference point cloud, qₑ represents an e^{th} denoised element point cloud data captured by the sensor, R represents the rotation matrix, and t represents a translation vector;
performing three-dimensional reconstruction of the obstacle element in the embedded map to obtain the embedded obstacle map based on the map position and orientation and denoised element-point cloud data.

In some embodiments of the present disclosure, establishing an obstacle avoidance path for the unmanned aerial vehicle based on a preset unmanned aerial vehicle target location, unmanned aerial vehicle position, unmanned aerial vehicle flight trajectory, and embedded obstacle map, includes:
marking potential path points on the embedded obstacle map based on the unmanned aerial vehicle target location and unmanned aerial vehicle position;
determining a current path point of the potential path points based on the unmanned aerial vehicle position;
calculating path point response values of the potential path points based on the embedded obstacle map and the unmanned aerial vehicle flight trajectory;
determining an obstacle avoidance path of the unmanned aerial vehicle based on the response values.

In order to solve the above problems, the present disclosure also provides a dual screen display system for an unmanned aerial vehicle based on an embedded map according to claim, where the system includes:
an unmanned aerial vehicle data acquisition module, configured to obtain flight data and environmental perception data of the unmanned aerial vehicle on the embedded map, where the flight data includes position, altitude, velocity, and attitude information, and the environmental perception data includes laser radar point cloud data, infrared image data, and ultrasonic sensor data; calibrate the flight data and environmental perception data to obtain calibrated flight data and calibrated environmental perception data,
an obstacle element marking module, configured to mark a position and a flight trajectory of the unmanned aerial vehicle based on the calibrated flight data, and mark an obstacle element in a corresponding flight area of the unmanned aerial vehicle based on the calibrated environment perception data;
an obstacle map construction module, configured to calculate an obstacle coefficient of the obstacle element and perform three-dimensional reconstruction of the obstacle element in the embedded map to obtain the embedded obstacle map based on the obstacle coefficient;
a first display screen establishment module, configured to establish an obstacle avoidance path for the unmanned aerial vehicle based on a preset unmanned aerial vehicle target location, unmanned aerial vehicle position, unmanned aerial vehicle flight trajectory, and embedded obstacle map, construct a first display screen for the unmanned aerial vehicle based on the unmanned aerial vehicle position, unmanned aerial vehicle flight trajectory, embedded obstacle map, and obstacle avoidance path; and
a second display screen establishment module, configured to obtain real-time flight video of the unmanned aerial vehicle, identify a video subject of the real-time flight video, construct an identification box and attribute information of the video subject, construct a second display screen of the unmanned aerial vehicle based on the video subject, identification box, and attribute information, establish a dual screen collaboration rule of the unmanned aerial vehicle, and execute a dual screen display of the first display screen and the second display screen according to the dual screen collaboration rule.

Compared to the problems described in the background technology, firstly, by obtaining and calibrating the flight data and environmental perception data of the unmanned aerial vehicle, the system ensures the accuracy and reliability of the data, thereby providing a solid foundation for subsequent flight decisions. The precise marking of position, altitude, velocity, and attitude information enables the operator to grasp the flight state of the unmanned aerial vehicle in real time. The calibration of laser radar point cloud data, infrared image data, and ultrasonic sensor data improves the accuracy of environmental perception and effectively avoids potential collision risks. Secondly, the three-dimensional reconstruction of the embedded obstacle map provides a detailed environmental model for the unmanned aerial vehicle, enabling it to perform more intelligent path planning and obstacle avoidance in complex environments. The calculation of the obstacle coefficient further enhances the pertinence of obstacle avoidance strategies. The construction of the first display screen ensures the safe flight of the unmanned aerial vehicle when facing different difficulty obstacles. In addition, the construction of the first display screen makes the unmanned aerial vehicle's flight trajectory, position, obstacle elements, and obstacle avoidance path clear at a glance, greatly improving the operator's situational awareness ability and facilitating effective flight command and decision-making. In addition, the real-time flight video analysis and video subject recognition of the second display screen provide powerful visual assistance for the unmanned aerial vehicle to perform specific tasks (such as monitoring, search, rescue, etc.). The real-time display of recognition box and attribute information enables the operator to quickly identify and respond to key targets in the video. Finally, the establishment of the dual screen collaboration rule achieves seamless integration and collaborative work between the first and second display screens, thus improving operational efficiency and reducing operational complexity. Therefore, the present disclosure improves the operational efficiency of the unmanned aerial vehicles in complex tasks.

### BRIEF DESCRIPTION OF DRAWINGS

FIG. 1 is a flowchart of a dual screen display method for an unmanned aerial vehicle based on an embedded map provided by the present disclosure.

FIG. 2 is a module schematic diagram for implementing a dual screen display system for an unmanned aerial vehicle based on an embedded map provided by the present disclosure.

The purpose, functional characteristics, and advantages of the present disclosure will be further explained in combination with the embodiments and with reference to the accompanying drawings.

### DESCRIPTION OF EMBODIMENTS

It should be understood that the specific embodiments described herein are only used to explain the present disclosure and are not intended to limit the present disclosure.

An embodiment of present application provides a dual screen display method for an unmanned aerial vehicle based on an embedded map. An executing subject of the dual screen display method for an unmanned aerial vehicle based on an embedded map includes but is not limited to at least one electronic device that can be configured to execute the method provided in the embodiments of the present application, such as a server or a terminal. In other words, the dual screen display method and system for an unmanned aerial vehicle based on an embedded map can be executed by software or hardware installed on terminal devices or server devices. The server includes but is not limited to a single server, a server cluster, a cloud server, or a cloud server cluster

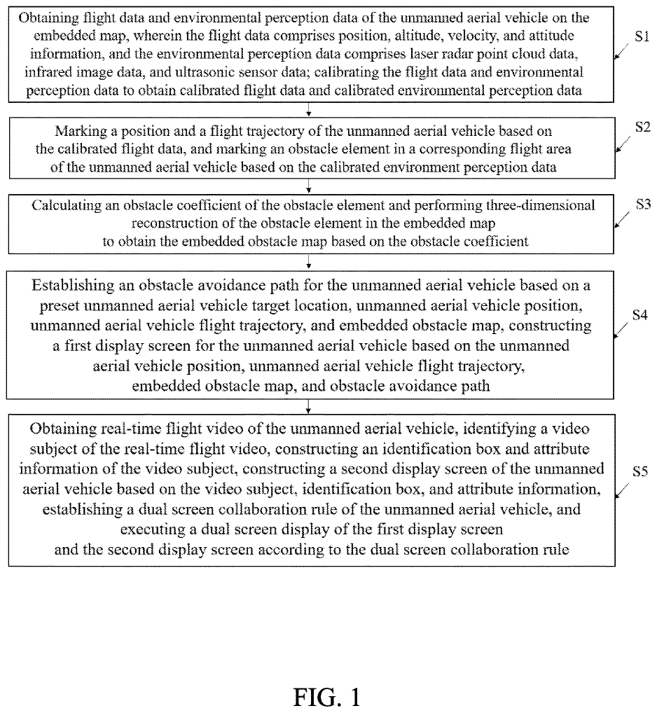

Referring to FIG. 1, an embodiment of the present invention, it is a flowchart of a dual screen display method for an unmanned aerial vehicle based on an embedded map provided in an embodiment of the present disclosure. In this embodiment, the dual screen display method for an unmanned aerial vehicle based on an embedded map includes:

S1: obtaining flight data and environmental perception data of the unmanned aerial vehicle on the embedded map, where the flight data includes position, altitude, velocity, and attitude information, and the environmental perception data includes laser radar point cloud data, infrared image data, and ultrasonic sensor data; calibrating the flight data and environmental perception data to obtain calibrated flight data and calibrated environmental perception data.

It should be explained that the position refers to a specific coordinate position of the unmanned aerial vehicle on the embedded map, the height refers to a vertical distance of the unmanned aerial vehicle relative to the ground, the velocity refers to a flight velocity of the unmanned aerial vehicle, and the attitude information refers to a direction and a tilt state of the unmanned aerial vehicle in three-dimensional space. The laser radar point cloud data refers to data obtained through a laser radar sensor, the infrared image data refers to data captured by an infrared camera, and the ultrasonic sensor data refers to data obtained through an ultrasonic sensor.

The present disclosure calibrates the flight data and environmental perception data, and obtains calibrated flight data and calibrated environmental perception data to make the data more accurate and reliable, thereby suitable for precise navigation and control of the unmanned aerial vehicle

In an implementation mode, the calibrating the flight data and environmental perception data to obtain calibrated flight data and calibrated environmental perception data, including:
identifying a sensor type for the flight data and environmental perception data;
analyzing flight data characteristics and environmental perception data characteristics of the flight data and environmental perception data;
defining a joint calibration algorithm for the flight data and environmental perception data based on the sensor type, flight data characteristics, and environmental perception data characteristics;
determining a feasible parameter range of the joint calibration algorithm;
calibrating the flight data and environmental perception data using the joint calibration algorithm through the feasible parameter range and obtaining the calibrated flight data and calibrated environmental perception data.

Where the sensor type refers to type of sensor used to collect flight data and environmental perception data. This may include but is not limited to inertial measurement units (IMUs), global positioning systems (GPS), radar, laser rangefinders (laser radar), camera, ultrasonic sensor, etc. The flight data characteristics refer to the quality and attributes of the flight data, including but not limited to the accuracy, resolution, sampling rate, noise level, dynamic range, nonlinear error, system deviation, time drift, etc. of the data. The environmental perception data characteristics refer to the quality and attributes of the data collected by the environmental perception sensor, such as resolution, accuracy, range, angle of view, occlusion, reflectivity, environmental interference, etc. The joint calibration algorithm refers to an algorithm used to calibrate flight data and environmental perception data at the same time to reduce the system error and deviation between different sensors. The parameter feasible range refers to a range of acceptable parameter values in the joint calibration algorithm, and the calibrated flight data refers to a range of acceptable parameter values in the joint calibration algorithm. The calibrated environmental perception data refers to the environmental perception data processed by the joint calibration algorithm.

In an implementation mode, the flight data and environmental perception data can be calibrated using the joint calibration algorithm through the parameter feasible range, and the calibrated flight data and environmental perception data can be jointly processed through statistical methods (such as least squares) and filtering techniques (such as Kalman filtering).

S2: Marking a position and a flight trajectory of the unmanned aerial vehicle based on the calibrated flight data and marking an obstacle element in a corresponding flight area of the unmanned aerial vehicle based on the calibrated environment perception data.

The present disclosure is based on the calibrated flight data and marks the unmanned aerial vehicle position and unmanned aerial vehicle flight trajectory, which provides a basis for later unmanned aerial vehicle flight optimization.

In an implementation mode, marking a position and a flight trajectory of the unmanned aerial vehicle based on the calibrated flight data, including:
extracting a position information from the calibrated flight data and determining the position of the unmanned aerial vehicle based on the position information;
marking a trajectory starting point of the unmanned aerial vehicle;
defining a trajectory data structure of the unmanned aerial vehicle based on the trajectory starting point;
determining trajectory points of the unmanned aerial vehicle based on the position information;
adding the trajectory points to the trajectory data structure to obtain an initial flight trajectory of the unmanned aerial vehicle; and
performing smooth treatment on the initial flight trajectory to obtain the unmanned aerial vehicle flight trajectory of the unmanned aerial vehicle.

Where the position information refers to the specific coordinate information of the unmanned aerial vehicle extracted from the calibrated flight data, usually including the position in two-dimensional or three-dimensional space, such as latitude, longitude, and altitude. The unmanned aerial vehicle position refers to a specific position information point, representing an exact position of the unmanned aerial vehicle at a certain moment. The trajectory starting point refers to a starting point of the unmanned aerial vehicle flight trajectory, usually the position at the time of takeoff. The trajectory data structure refers to the data structure used to store and represent the unmanned aerial vehicle flight trajectory, which can be an array, a list, or a database. The trajectory points refer to a single data point in the flight trajectory, and each point contains the position information of the unmanned aerial vehicle and corresponding timestamp. The initial flight trajectory refers to a preliminary flight trajectory that is constructed based on the extracted position information, the unmanned aerial vehicle flight trajectory refers to a final flight trajectory that has been smoothed and optimized.

In an implementation mode, performing smooth treatment on the initial flight trajectory to obtain the unmanned aerial vehicle flight trajectory of the unmanned aerial vehicle, including:
defining a sliding window for the initial flight trajectory;
determining a trajectory point weight corresponding to the initial flight trajectory;
calculating a smoothness coefficient of the trajectory point using the following formula based on the sliding window and trajectory point weight:

$${P}_{k} = {\sum }_{c = k - N / 2}^{k + N / 2} {ρ}_{c} {ω}_{c} / {\sum }_{c = k - N / 2}^{k + N / 2} {ρ}_{c}$$

where Pₖ represents the smoothness coefficient of the trajectory point corresponding to the time point k, k represents the time point k, N represents a size of the sliding window, ωc represents a trajectory point at the time point c, and ρc represents the trajectory point weight corresponding to the trajectory point at the time point c;
preforming smooth treatment on the initial flight trajectory based on the smoothness coefficient to obtain the unmanned aerial vehicle flight trajectory.

Where the sliding window refers to a data window with a fixed size that slides onto the initial flight trajectory. The trajectory point weight refers to a numerical value assigned to each trajectory point, which represents the importance of the trajectory point relative to other trajectory points in the smoothing process. The smoothness coefficient refers to a numerical value used to adjust the contribution of each trajectory point to the final smooth trajectory.

The present disclosure is based on the calibrated environmental perception data and marks the obstacle element corresponding to the flight area of the unmanned aerial vehicle, which can effectively mark the obstacle element in the unmanned aerial vehicle flight area and ensure flight safety.

In an implementation mode, marking the obstacle element corresponding to the flight area of the unmanned aerial vehicle based on the calibrated environmental perception data, including:
determining a RGB image of the flight area, three-dimensional point cloud data, and detecting a heat source based on the calibrated environmental perception data;
performing subject separation on the RGB image of the flight area to obtain an image subject;
using the three-dimensional point cloud data to supplement depth information of the image subject and obtaining a supplementary image subject;
extracting image subject features and heat source features of the supplementary image subject and a detected heat source;
using a trained obstacle recognition model to identify the obstacle element in the flight area based on the image subject features and heat source features.

Where the RGB image of the flight area refers to color image of the flight area captured by a RGB camera carried by the unmanned aerial vehicle, the three-dimensional point cloud data refers to the three-dimensional point cloud data of the flight area obtained by laser radar or other depth sensors, the detected heat source refers to heat source information in the flight area detected by the infrared sensor, a main target or a region is separated from the RGB image of the flight area, usually is a potential obstacle (such as buildings, trees, vehicles, etc.), and the supplementary image subject refers to a combination of the depth information of the three-dimensional point cloud data with the image subject in the RGB image to generate a subject image with depth information. The image subject features refer to features extracted from the supplementary image subject, including shape, texture, color, depth, etc. The heat source features refer to features extracted from detected heat sources, including temperature distribution, shape, size, etc. The obstacle element refers to objects or areas in the flight area that may hinder the unmanned aerial vehicle's flight, such as buildings, trees, wires, vehicles, pedestrians, etc. The obstacle recognition model refers to a model used to recognize obstacle information, which can be trained using neural networks.

In an implementation mode, the depth information of the image subject can be supplemented using the three-dimensional point cloud data to obtain the supplementary image subject, which can be implemented using OpenCV and Open3D software.

S3: Calculating an obstacle coefficient of the obstacle element and performing three-dimensional reconstruction of the obstacle element in the embedded map to obtain the embedded obstacle map based on the obstacle coefficient.

The calculation of the obstacle coefficient for the obstacle element in the present disclosure can provide a basis for optimizing the flight path of the unmanned aerial vehicle, thereby improving the safety of unmanned aerial vehicle flight.

In an implementation mode, calculating the obstacle coefficient of the obstacle element, includes:
identifying an obstacle type of the obstacle elements, where the obstacle type includes a static obstacle, a dynamic obstacle, and a living obstacle;
extracting obstacle features of the obstacle type, where the obstacle features include an obstacle distance, an obstacle volume, an obstacle dynamism, and a heat source value;
defining obstacle feature scores for the obstacle features;
normalizing the obstacle features to obtain normalized obstacle features, where the normalized obstacle features include a normalized obstacle distance, a normalized obstacle volume, a normalized obstacle dynamism, and a normalized heat source value;
calculating the obstacle coefficient of the obstacle element based on the normalized obstacle distance, normalized obstacle volume, normalized obstacle dynamism, normalized heat source value, and obstacle feature scores.

Where the static obstacle refers to an obstacle with fixed and unchanged position, such as buildings, trees, electric line pole, etc. The dynamic obstacle refers to an obstacle whose position changes over time, such as vehicles, unmanned aerial vehicles, mobile devices, etc. The living obstacle refers to an obstacle with life characteristics, such as birds, animals, pedestrians, etc. The obstacle distance refers to a straight-line distance between the obstacle and the unmanned aerial vehicle, the obstacle volume refers to a volume of the obstacle in three-dimensional space, the obstacle dynamism refers to a motion state of the obstacle (such as velocity and direction), the heat source value refers to a thermal radiation intensity of the obstacle (such as temperature value), and the normalized obstacle volume refers to a volume of the obstacle in a three-dimensional space. The normalized obstacle distance refers to a distance value that normalizes the obstacle distance to a range of [0,1][0,1]. The normalized obstacle volume refers to a value that normalizes the obstacle volume to a range of [0,1][0,1], the normalized obstacle dynamism refers to a value that normalizes the obstacle dynamism to a range of [0,1][0,1], the normalized heat source value refers to a value that normalizes the heat source value to a range of [0,1][0,1], and the obstacle feature scores refer to scores assigned to each obstacle feature, reflecting the degree of influence of that feature on the obstacle coefficient. The obstacle coefficient refers to an indicator calculated by integrating the obstacle feature scores and the normalized obstacle features, used to quantify a threat level of the obstacle to unmanned aerial vehicle flight.

In an implementation mode, calculating the obstacle coefficient of the obstacle element based on the normalized obstacle distance, normalized obstacle volume, normalized obstacle dynamism, normalized heat source value, and obstacle feature scores, including:
defining an environmental impact factor of the obstacle element, where the environmental impact factor includes wind velocity and lighting conditions;
calculating the obstacle coefficient of the obstacle element using the following formula based on the wind velocity, lighting conditions, normalized obstacle distance, normalized obstacle volume, normalized obstacle dynamism, normalized heat source value, and obstacle feature scores:

Uₒ=(ω_{d}·dₙ+ωₛ·sₙ+ωᵥ·vₙ+ωₕ·hₙ)·(1+α·wind+σ·light)
where Uo represents the obstacle coefficient of the obstacle element, dₙ represents the normalized obstacle distance, ω_{d} represents an obstacle feature score of the normalized obstacle distance, Sₙ represents the normalized obstacle volume, ωₛ represents an obstacle feature score of the normalized obstacle volume, vₙ represents the normalized obstacle dynamism, co represents an obstacle feature score of the normalized obstacle dynamism, hₙ represents the normalized heat source value, ωₕ represents an obstacle feature score of the normalized heat source value, wind represents the wind velocity, α represents an influence weight of the wind velocity, light represents the lighting conditions, and σ represents an influence weight of the lighting conditions.

Where the wind velocity refers to the air flow velocity within the unmanned aerial vehicle flight area, the lighting conditions refer to the light intensity and direction of the unmanned aerial vehicle flight area, and the influence weight refers to the degree of influence of environmental factors during the unmanned aerial vehicle flight process.

According to the obstacle coefficient, the present disclosure performs the three-dimensional reconstruction of the obstacle element in the embedded map to obtain the embedded obstacle map, which can provide a basis for obstacle avoidance of the unmanned aerial vehicle.

In an implementation mode, performing three-dimensional reconstruction of the obstacle element in the embedded map to obtain the embedded obstacle map based on the obstacle coefficient, including:
determining a to-be-modeled element for the obstacle element based on the obstacle coefficient;
collecting point cloud data of the to-be-modeled element;
denoising the point cloud data of the to-be-modeled element to obtain denoised element-point cloud data;
determining a reference point cloud of the embedded map;
defining a rotation matrix of the denoised element-point cloud data in the embedded map;
calculating a map position and orientation of a sensor corresponding to the denoised element-point cloud data on the embedded map using the following formula based on the reference point cloud, rotation matrix, and element-point cloud data:

$$E = {\sum }_{e = 1}^{m} {‖ {p}_{e} - R ( {q}_{e} ) - t ‖}^{2}$$

where, E represents a map position and orientation of an e^{th} denoised element-point cloud data sensor in the embedded map, pe represents a point position corresponding to the e^{th} denoised element-point cloud data captured by the sensor in the reference point cloud, qe represents the e^{th} denoised element point cloud data captured by the sensor, R represents the rotation matrix, and t represents a translation vector;
performing three-dimensional reconstruction of the obstacle element in the embedded map to obtain the embedded obstacle map based on the map position and orientation and denoised element-point cloud data.

Where the to-be-modeled element refers to an object identified as an obstacle in the unmanned aerial vehicle flight area. The element-point cloud data refers to the point cloud data of the to-be-modeled obstacle element collected by the sensor (such as laser radar or RGB-D cameras), which contains geometric information of the obstacle element. The denoised element point cloud data refers to the data obtained by denoising original element point cloud data (such as removing outliers, smoothing, etc.) to improve the accuracy of the data and the efficiency of subsequent processing. The reference point cloud refers to a known point cloud in the embedded map, which is usually a part of the global map constructed by SLAM algorithm and used for positioning and mapping. The rotation matrix refers to a 3×3 matrix used to describe a rotation relationship of denoised element point cloud data relative to the reference point cloud, the map position and orientation refers to the position and direction of the sensor in the embedded map, the embedded map refers to the original map used for unmanned aerial vehicle flight navigation, and the embedded obstacle map refers to a three-dimensional map containing environmental obstacles and features, which is used for unmanned aerial vehicle navigation and obstacle avoidance.

S4: Establishing an obstacle avoidance path for the unmanned aerial vehicle based on a preset unmanned aerial vehicle target location, unmanned aerial vehicle position, unmanned aerial vehicle flight trajectory, and embedded obstacle map, constructing a first display screen for the unmanned aerial vehicle based on the unmanned aerial vehicle position, unmanned aerial vehicle flight trajectory, embedded obstacle map, and obstacle avoidance path.

The present disclosure establishes the obstacle avoidance path for the unmanned aerial vehicle based on the preset unmanned aerial vehicle target location, unmanned aerial vehicle position, unmanned aerial vehicle flight trajectory, and embedded obstacle map to ensure the safety of the unmanned aerial vehicle and the smooth completion of the mission.

In an implementation mode, establishing an obstacle avoidance path for the unmanned aerial vehicle based on a preset unmanned aerial vehicle target location, unmanned aerial vehicle position, unmanned aerial vehicle flight trajectory, and embedded obstacle map, including:
marking potential path points on the embedded obstacle map based on the unmanned aerial vehicle target location and unmanned aerial vehicle position;
determining a current path point of the potential path points based on the unmanned aerial vehicle position;
calculating path point response values of the potential path points based on the embedded obstacle map and the unmanned aerial vehicle flight trajectory;
determining an obstacle avoidance path of the unmanned aerial vehicle based on the response values.

Where the potential path points refer to a series of pre-selected position points that the unmanned aerial vehicle may pass through during the process of flying from the current position to the target location. The current path point refers to the current path point of the unmanned aerial vehicle, and the path point response values refers to an evaluation index of the potential path points, which reflects the flight difficulty, safety, energy consumption or other costs from the current unmanned aerial vehicle position to the path points. The obstacle avoidance path refers to the safe flight path planned by the unmanned aerial vehicle during the flight to avoid collisions.

In an implementation mode, calculating the path point response values of the potential path points based on the embedded obstacle map and the unmanned aerial vehicle flight trajectory can be achieved using a cost map.

The present disclosure constructs a first display screen of the unmanned aerial vehicle based on the unmanned aerial vehicle position, flight trajectory, embedded obstacle map, and obstacle avoidance path to obtain an intuitive display screen, thereby better monitoring the unmanned aerial vehicle's flight state and executing obstacle avoidance operations. Where the first display screen refers to a screen interface that an operator sees on the first screen of the unmanned aerial vehicle control system or monitoring system, including map view, unmanned aerial vehicle icon, unmanned aerial vehicle flight trajectory, embedded obstacle map, obstacle avoidance path, and state information (key flight parameters such as unmanned aerial vehicle velocity, altitude, course heading, battery level, signal strength, etc.).

S5: Obtaining real-time flight video of the unmanned aerial vehicle, identifying a video subject of the real-time flight video, constructing an identification box and attribute information of the video subject, constructing a second display screen of the unmanned aerial vehicle based on the video subject, identification box, and attribute information, establishing a dual screen collaboration rule of the unmanned aerial vehicle, and executing a dual screen display of the first display screen and the second display screen according to the dual screen collaboration rule.

It should be explained that the real-time flight video refers to the image stream captured and transmitted in real time by the camera carried by the unmanned aerial vehicle during the flight process. The recognition box refers to a rectangular box used to mark and locate specific objects (such as people, vehicles, animals, etc.) in the real-time flight video. The attribute information refers to a series of data descriptions related to the video subject within the recognition box, such as category, ID, the description of behavior, distance, etc. the second display image refers to a display screen interface specifically used in the unmanned aerial vehicle control system or monitoring system to display real-time flight videos, recognition box, and attribute information.

The establishment of dual screen collaboration rule for the unmanned aerial vehicle in the present disclosure can be more efficient and safer, thereby improving the operator's work efficiency and the overall performance of the unmanned aerial vehicle. The dual screen collaboration rule includes information synchronization rules, interaction design rules, visual coordination rules, warning and notification rules, user customization rules, and system integration rules.

Compared to the problems described in the background technology, firstly, by obtaining and calibrating the flight data and environmental perception data of the unmanned aerial vehicle, the system ensures the accuracy and reliability of the data, thereby providing a solid foundation for subsequent flight decisions. The precise marking of position, altitude, velocity, and attitude information enables the operator to grasp the flight state of the unmanned aerial vehicle in real time. The calibration of laser radar point cloud data, infrared image data, and ultrasonic sensor data improves the accuracy of environmental perception and effectively avoids potential collision risks. Secondly, the three-dimensional reconstruction of the embedded obstacle map provides a detailed environmental model for the unmanned aerial vehicle, enabling it to perform more intelligent path planning and obstacle avoidance in complex environments. The calculation of obstacle coefficients further enhances the pertinence of obstacle avoidance strategies, ensuring the safe flight of the unmanned aerial vehicle when facing different difficulty obstacles, and the construction of the first display screen makes the unmanned aerial vehicle's flight trajectory, location, obstacle elements, and obstacle avoidance path clear at a glance, thereby greatly enhancing the operator’ situational awareness ability and facilitating effective flight command and decision-making. Besides that, the real-time flight video analysis and video subject recognition of the second display screen provide powerful visual assistance for the unmanned aerial vehicle to perform specific tasks such as monitoring, search, rescue, etc. The real-time display of the recognition box and attribute information enables the operator to quickly identify and respond to key targets in the video. Finally, the establishment of the dual screen collaboration rule achieves seamless integration and collaborative work between the first display screen and the second display screen, thereby improving operational efficiency and reducing operational complexity. Therefore, the present disclosure improves the operational efficiency of the unmanned aerial vehicle in complex tasks.

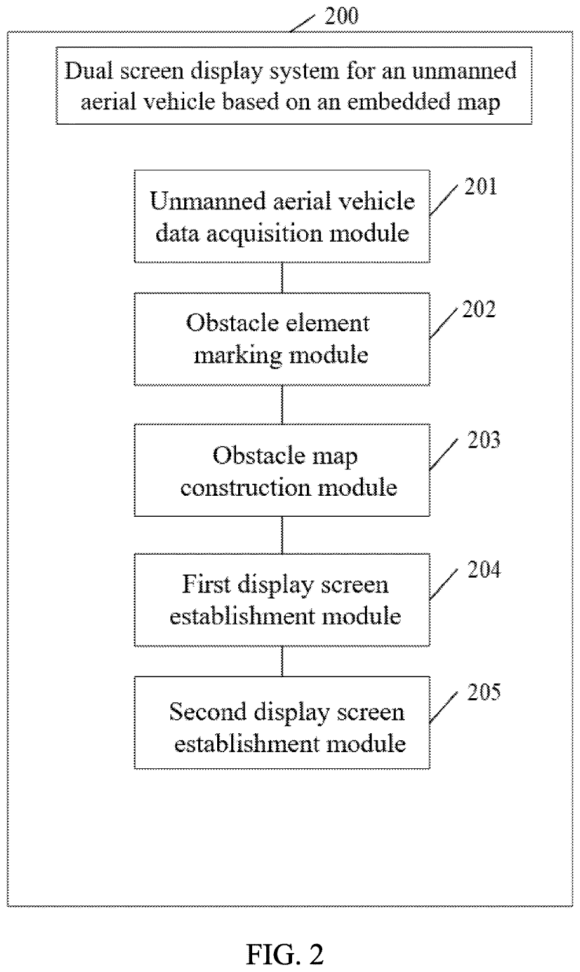

As shown in FIG. 2, it is a functional module diagram of a dual screen display system for an unmanned aerial vehicle based on an embedded map according to the present disclosure.

The dual screen display system 200 for an unmanned aerial vehicle based on an embedded map described in the present disclosure can be installed in an electronic device. According to the implemented functions, the dual screen display system 200 for an unmanned aerial vehicle based on an embedded map may include an unmanned aerial vehicle data acquisition module 201, an obstacle element marking module 202, an obstacle map construction module 203, a first display screen establishment module 204, and a second display screen establishment module 205. The module described in the present disclosure can also be referred to as a unit, which refers to a series of computer program segments that can be executed by a processor of the electronic device and can complete fixed functions, stored in a memory of the electronic device.

In the embodiments of the present disclosure, the functions of each module/unit are as follows.

The unmanned aerial vehicle data acquisition module 201 is configured to obtain flight data and environmental perception data of the unmanned aerial vehicle on the embedded map, where the flight data includes position, altitude, velocity, and attitude information, and the environmental perception data includes laser radar point cloud data, infrared image data, and ultrasonic sensor data; calibrate the flight data and environmental perception data to obtain calibrated flight data and calibrated environmental perception data.

The obstacle element marking module 202 is configured to mark a position and a flight trajectory of the unmanned aerial vehicle based on the calibrated flight data, and mark an obstacle element in a corresponding flight area of the unmanned aerial vehicle based on the calibrated environment perception data.

The obstacle map construction module 203 is configured to calculate an obstacle coefficient of the obstacle element and perform three-dimensional reconstruction of the obstacle element in the embedded map to obtain the embedded obstacle map based on the obstacle coefficient.

The first display screen establishment module 204 is configured to establish an obstacle avoidance path for the unmanned aerial vehicle based on a preset unmanned aerial vehicle target location, unmanned aerial vehicle position, unmanned aerial vehicle flight trajectory, and embedded obstacle map, construct a first display screen for the unmanned aerial vehicle based on the unmanned aerial vehicle position, unmanned aerial vehicle flight trajectory, embedded obstacle map, and obstacle avoidance path.

The second display screen establishment module 205 is configured to obtain real-time flight video of the unmanned aerial vehicle, identify a video subject of the real-time flight video, construct an identification box and attribute information of the video subject, construct a second display screen of the unmanned aerial vehicle based on the video subject, identification box, and attribute information, establish a dual screen collaboration rule of the unmanned aerial vehicle, and execute a dual screen display of the first display screen and the second display screen according to the dual screen collaboration rule.

Specially, the modules in the dual screen display system 200 for an unmanned aerial vehicle based on an embedded map described in the embodiments of the present disclosure adopt the same technical means as the dual screen display method for an unmanned aerial vehicle based on an embedded map provided described in FIG. 1, and can produce the same technical effects, which will not be repeated here.

For those skilled in the art, it is obvious that the present disclosure is not limited to the details of the exemplary embodiments described above, and can be implemented in other specific forms without departing from the spirit or essential features of the present disclosure.

Finally, it should be noted that the above embodiments are only used to illustrate the technical solution of the present disclosure and not to limit it. Although the present disclosure has been described in detail with reference to the preferred embodiments, those skilled in the art should understand that the technical solution of the present disclosure can be modified or equivalently replaced without departing from the spirit and scope of the technical solution of the present disclosure.

What is claimed is:

1. A dual screen display method for an unmanned aerial vehicle based on an embedded map, comprising:
obtaining flight data and environmental perception data of the unmanned aerial vehicle on the embedded map, wherein the flight data comprises position, altitude, velocity, and attitude information, and the environmental perception data comprises laser radar point cloud data, infrared image data, and ultrasonic sensor data; calibrating the flight data and environmental perception data to obtain calibrated flight data and calibrated environmental perception data;
marking a position and a flight trajectory of the unmanned aerial vehicle based on the calibrated flight data, and marking an obstacle element in a corresponding flight area of the unmanned aerial vehicle based on the calibrated environment perception data;
calculating an obstacle coefficient of the obstacle element and performing three-dimensional reconstruction of the obstacle element in the embedded map to obtain the embedded obstacle map based on the obstacle coefficient;
establishing an obstacle avoidance path for the unmanned aerial vehicle based on a preset unmanned aerial vehicle target location, unmanned aerial vehicle position, unmanned aerial vehicle flight trajectory, and embedded obstacle map, constructing a first display screen for the unmanned aerial vehicle based on the unmanned aerial vehicle position, unmanned aerial vehicle flight trajectory, embedded obstacle map, and obstacle avoidance path;
obtaining real-time flight video of the unmanned aerial vehicle, identifying a video subject of the real-time flight video, constructing an identification box and attribute information of the video subject, constructing a second display screen of the unmanned aerial vehicle based on the video subject, identification box, and attribute information, establishing a dual screen collaboration rule of the unmanned aerial vehicle, and executing a dual screen display of the first display screen and the second display screen according to the dual screen collaboration rule.

2. The dual screen display method for an unmanned aerial vehicle based on an embedded map according to claim 1, wherein calibrating the flight data and environmental perception data to obtain calibrated flight data and calibrated environmental perception data comprises:
identifying a sensor type for the flight data and environmental perception data;
analyzing flight data characteristics and environmental perception data characteristics of the flight data and environmental perception data;
defining a joint calibration algorithm for the flight data and environmental perception data based on the sensor type, flight data characteristics, and environmental perception data characteristics;
determining a feasible parameter range of the joint calibration algorithm;
calibrating the flight data and environmental perception data using the joint calibration algorithm through the feasible parameter range and obtaining the calibrated flight data and calibrated environmental perception data.

3. The dual screen display method for an unmanned aerial vehicle based on an embedded map according to claim 2, wherein marking a position and a flight trajectory of the unmanned aerial vehicle based on the calibrated flight data, comprises:
extracting a position information from the calibrated flight data and determining the position of the unmanned aerial vehicle based on the position information;
marking a trajectory starting point of the unmanned aerial vehicle;
defining a trajectory data structure of the unmanned aerial vehicle based on the trajectory starting point;
determining trajectory points of the unmanned aerial vehicle based on the position information;
adding the trajectory points to the trajectory data structure to obtain an initial flight trajectory of the unmanned aerial vehicle;
performing smooth treatment on the initial flight trajectory to obtain the unmanned aerial vehicle flight trajectory of the unmanned aerial vehicle.

4. The dual screen display method for an unmanned aerial vehicle based on an embedded map according to claim 3, wherein performing smooth treatment on the initial flight trajectory to obtain the unmanned aerial vehicle flight trajectory of the unmanned aerial vehicle comprises:
defining a sliding window for the initial flight trajectory;
determining a trajectory point weight corresponding to the initial flight trajectory;
calculating a smoothness coefficient of the trajectory point using the following formula based on the sliding window and trajectory point weight:
$${P}_{k} = {\sum }_{c = k - N / 2}^{k + N / 2} {ρ}_{c} {ω}_{c} / {\sum }_{c = k - N / 2}^{k + N / 2} {ρ}_{c}$$
where Pₖ represents the smoothness coefficient of the trajectory point corresponding to the time point k, k represents the time point k, N represents a size of the sliding window, ω_{c}, represents a trajectory point at the time point c, and ρc represents the trajectory point weight corresponding to the trajectory point at the time point c;
preforming smooth treatment on the initial flight trajectory based on the smoothness coefficient to obtain the unmanned aerial vehicle flight trajectory.

5. The dual screen display method for an unmanned aerial vehicle based on an embedded map according to claim 4, wherein marking the obstacle element corresponding to the flight area of the unmanned aerial vehicle based on the calibrated environmental perception data comprises:
determining a RGB image of the flight area, three-dimensional point cloud data, and detecting a heat source based on the calibrated environmental perception data;
performing subject separation on the RGB image of the flight area to obtain an image subject;
using the three-dimensional point cloud data to supplement depth information of the image subject and obtaining a supplementary image subject;
extracting image subject features and heat source features of the supplementary image subject and a detected heat source;
using a trained obstacle recognition model to identify the obstacle element in the flight area based on the image subject features and heat source features.

6. The dual screen display method for an unmanned aerial vehicle based on an embedded map according to claim 5, wherein calculating the obstacle coefficient of the obstacle element comprises:
identifying an obstacle type of the obstacle element, where the obstacle type comprises a static obstacle, a dynamic obstacle, and a living obstacle;
extracting obstacle features of the obstacle type, where the obstacle features comprise an obstacle distance, an obstacle volume, an obstacle dynamism, and a heat source value;
defining obstacle feature scores for the obstacle features;
normalizing the obstacle features to obtain normalized obstacle features, where the normalized obstacle features include a normalized obstacle distance, a normalized obstacle volume, a normalized obstacle dynamism, and a normalized heat source value;
calculating the obstacle coefficient of the obstacle element based on the normalized obstacle distance, normalized obstacle volume, normalized obstacle dynamism, normalized heat source value, and obstacle feature scores.

7. The dual screen display method for an unmanned aerial vehicle based on an embedded map according to claim 6, wherein calculating the obstacle coefficient of the obstacle element based on the normalized obstacle distance, normalized obstacle volume, normalized obstacle dynamism, normalized heat source value, and obstacle feature scores, comprises:
defining an environmental impact factor of the obstacle element, where the environmental impact factor comprises wind velocity and lighting conditions;
calculating the obstacle coefficient of the obstacle element using the following formula based on the wind velocity, lighting conditions, normalized obstacle distance, normalized obstacle volume, normalized obstacle dynamism, normalized heat source value, and obstacle feature scores:
Uₒ=(ω_{d}·dₙ+ωₛ·sₙ+ωᵥ·vₙ+ωₕ·hₙ)·(1+α·wind+σ·light)
wherein, Uₒ represents the obstacle coefficient of the obstacle element, dₙ represents the normalized obstacle distance, ω_{d} represents an obstacle feature score of the normalized obstacle distance, Sₙ represents the normalized obstacle volume, ωₛ represents an obstacle feature score of the normalized obstacle volume, vₙ represents the normalized obstacle dynamism, ωᵥ represents an obstacle feature score of the normalized obstacle dynamism, hₙ represents the normalized heat source value, ωₕ represents an obstacle feature score of the normalized heat source value, wind represents the wind velocity, α represents an influence weight of the wind velocity, light represents the lighting conditions, and σ represents an influence weight of the lighting conditions.

8. The dual screen display method for an unmanned aerial vehicle based on an embedded map according to claim 7, wherein performing three-dimensional reconstruction of the obstacle element in the embedded map to obtain the embedded obstacle map based on the obstacle coefficient comprises:
determining a to-be-modeled element for the obstacle element based on the obstacle coefficient;
collecting point cloud data of the to-be-modeled element;
denoising the point cloud data of the to-be-modeled element to obtain denoised element-point cloud data;
determining a reference point cloud of the embedded map;
defining a rotation matrix of the denoised element-point cloud data in the embedded map;
calculating a map position and orientation of a sensor corresponding to the denoised element-point cloud data on the embedded map using the following formula based on the reference point cloud, rotation matrix, and element-point cloud data:
$$E = {\sum }_{e = 1}^{m} {‖ {p}_{e} - R ( {q}_{e} ) - t ‖}^{2}$$
wherein, E represents a map position and orientation of an e^{th} denoised element-point cloud data sensor in the embedded map, pₑ represents a point position corresponding to the e^{th} denoised element-point cloud data captured by the sensor in the reference point cloud, qₑ represents an e^{th} denoised element point cloud data captured by the sensor, R represents the rotation matrix, and t represents a translation vector;
performing three-dimensional reconstruction of the obstacle element in the embedded map to obtain the embedded obstacle map based on the map position and orientation and denoised element-point cloud data.

9. The dual screen display method for an unmanned aerial vehicle based on an embedded map according to claim 8, wherein establishing an obstacle avoidance path for the unmanned aerial vehicle based on a preset unmanned aerial vehicle target location, unmanned aerial vehicle position, unmanned aerial vehicle flight trajectory, and embedded obstacle map, comprises:
marking potential path points on the embedded obstacle map based on the unmanned aerial vehicle target location and unmanned aerial vehicle position;
determining a current path point of the potential path points based on the unmanned aerial vehicle position;
calculating path point response values of the potential path points based on the embedded obstacle map and the unmanned aerial vehicle flight trajectory;
determining an obstacle avoidance path of the unmanned aerial vehicle based on the response values.

10. A dual screen display system for an unmanned aerial vehicle based on an embedded map, wherein the system comprises:
an unmanned aerial vehicle data acquisition module, configured to obtain flight data and environmental perception data of the unmanned aerial vehicle on the embedded map, wherein the flight data comprises position, altitude, velocity, and attitude information, and the environmental perception data comprises laser radar point cloud data, infrared image data, and ultrasonic sensor data; calibrate the flight data and environmental perception data to obtain calibrated flight data and calibrated environmental perception data,
an obstacle element marking module, configured to mark a position and a flight trajectory of the unmanned aerial vehicle based on the calibrated flight data, and mark an obstacle element in a corresponding flight area of the unmanned aerial vehicle based on the calibrated environment perception data;
an obstacle map construction module, configured to calculate an obstacle coefficient of the obstacle element and perform three-dimensional reconstruction of the obstacle element in the embedded map to obtain the embedded obstacle map based on the obstacle coefficient;
a first display screen establishment module, configured to establish an obstacle avoidance path for the unmanned aerial vehicle based on a preset unmanned aerial vehicle target location, unmanned aerial vehicle position, unmanned aerial vehicle flight trajectory, and embedded obstacle map, construct a first display screen for the unmanned aerial vehicle based on the unmanned aerial vehicle position, unmanned aerial vehicle flight trajectory, embedded obstacle map, and obstacle avoidance path; and
a second display screen establishment module, configured to obtain real-time flight video of the unmanned aerial vehicle, identify a video subject of the real-time flight video, construct an identification box and attribute information of the video subject, construct a second display screen of the unmanned aerial vehicle based on the video subject, identification box, and attribute information, establish a dual screen collaboration rule of the unmanned aerial vehicle, and execute a dual screen display of the first display screen and the second display screen according to the dual screen collaboration rule.
